(19) United States
(12) Patent Application Publication
(10) Pub. No.: US 2007/0006747 A1
(43) Pub. Date: Jan. 11, 2007

(54) Screen printing apparatus

(76) Inventor: John Edward Broughton, Ready Creek (AU)

Correspondence Address: HOFFMAN, WASSON & GITLER, P.C.;Crystal Center 2, Suite 522, 2461 South Clark Street, Arlington, VA, 22202, US

(21) Appl. No.: 11/474,968

(22) Filed: Jun. 27, 2006

(30) Foreign Application Priority Data
Jun. 27, 2005 (AU) 2005903374

(51) Int. Cl. B41F 15/04

(52) U.S. Cl. 101/115

(57) ABSTRACT

A screen printing apparatus having a base, a stator having a plurality of radially extending arms operatively connected to the base, a rotor having a plurality of radially extending arms operatively connected to the base, and a indexing drive mechanism for driving and indexing the rotor with respect to the stator, the drive mechanism including at least one link arm adapted to engage the engagement means of the rotor and control means to provide segmented movement of the rotor.

### TECHNICAL FIELD

This invention relates to screen printing apparatus and has particular relevance to carousel-type printing apparatus.

### BACKGROUND OF THE INVENTION

There are many examples of carousel-type printing apparatus which are provided with a central base, a rotor comprising a plurality of radially extending arms and a stator also providing a plurality of radially extending arms.

The stator arms carry printing heads and the rotor arms are adapted to carry articles for printing.

The movements of the rotor need to be synchronised in relation to print head positions provided by the stator.

The rotor must be rotated in accurately spaced segments and the height of the rotor needs to be adjusted to marry the individual printing heads with the article to be printed.

The nature of construction of the rotor is such that significant centrifugal and inertial forces are created as movement takes place and the rotor drive system needs to negate these forces.

It is one object of the present invention to provide a carousel-type screen printing apparatus including indexing means for ensuring correct synchronisation of the rotor and stator devices.

The process of screen printing involves the movement of a screen over an inked printing stencil.

Depending on the size of the image, the length of stroke of the screen should be accurately controlled and readily adjustable.

It is also an object of the present invention to provide a carousel-type screen printing apparatus where the position of the printing heads can be readily adjusted.

In many instances depending on the type of printing operation which is being carried out, heating devices are used to dry out newly applied inks.

It is a still further object of the present invention to provide a screen printing apparatus which is adapted to facilitate the positioning of portable dryers for the purpose of drying newly applied inks.

Further objects and advantages of the present invention will become apparent from the ensuing description, which is given by way of example.

### SUMMARY OF THE INVENTION

According to the present invention there is provided a screen printing apparatus having a base, a stator having a plurality of radially extending arms operatively connected to the base, a rotor having a plurality of radially extending arms operatively connected to the base, and a indexing drive mechanism for driving and indexing the rotor with respect to the stator, the drive mechanism including at least one link arm adapted to engage the engagement means of the rotor and control means to provide segmented movement of the rotor.

The screen printing apparatus according to the invention is usually a carousel-type screen printer. Simply stated, a carousel screen printer comprises a number of print stations spaced circumferentially about a vertical axis, a rotary turret mounting an equal number of work supports, commonly called pallets, also spaced circumferentially about the axis, and means for rotating the turret to align the pallets with the print stations in succession. Each pallet is elevated to and lowered from a raised printing position at each station. Each print station includes a print head supporting a screen frame mounting a printing screen having blocked and unblocked screen apertures or pores defining an image to be printed. Each print station also includes a so-called squeegee and flood bar movable back and forth across the upper side of the screen for spreading a printing ink across the screen and forcing the ink through the open screen pores. The images on the several printing screens define different portions or colour separations of a completed multicolour image to be printed.

Operation of a carousel screen printer involves (a) mounting a workpiece to be imprinted on each work pallet, (b) rotating the printer turret stepwise through its successive printing positions to rotate the work pallets to the print stations in succession, (c) elevating the pallets at the successive print stations to their printing positions in which the workpieces on the pallets contact the undersides of the respective printing screens, and (d) driving the squeegee and flood bars back and forth across the upper sides of their respective screens while the pallets are in their elevated printing positions to imprint the respective screen images on the workpieces. The several screen images are thereby imprinted in succession on each workpiece. Each of these several screen images is printed in a different single colour. The shapes of the several screen images and the different colours in which these images are successively imprinted on each workpiece are selected to produce on each workpiece a desired composite multicolour image.

Suitably, there may be a printing device associated with each of the extending arms of the stator, generally towards an outward end thereof. Printing devices may also be associated with the rotor arm, however due to the centrifugal force created by the movement of the rotor, the printing devices are suitably associated with the stator, and print support plates or assemblies are associated with the rotor arm, generally toward an outer end. Each printing device may have a printing head. The indexing drive mechanism will suitably rotate the rotor relative to the stator and also align the rotor and stator arm members to ensure high print quality.

The print support plates are normally moved in a controlled manner around the apparatus and aligned with the printing device provided on at least some of the stator arms. Each of the printing devices will preferably perform a different printing step. For example, if a print consisting of three colours is to be applied to a workpiece, three of the stator arms may have printing heads configured to each print one of the colours. The workpiece will be “loaded” onto a print support assembly and the apparatus will be guided through the printing process such that each of the printing heads applies its colour to the workpiece in a controlled manner. By providing each print support assembly with a workpiece and providing a print support assembly on each rotor arm, multiple workpieces may be printed easily and quickly.

The stator or the rotor may suitably be capable of being raised or lowered. The raising or lowering may typically be accomplished by a means for raising and lowering.

There are at least two preferred embodiments of the indexing drive mechanism. Each embodiment may preferably include a sensor means so that the indexing drive mechanism is capable of proper alignment with the rotor. According to a preferred embodiment, the sensor means may include a tube or similar associated with the rotor, the tube having a plurality of radially spaced slots or openings therein. The sensor means may detect the slots on the tube and control the indexing mechanism to engage the rotor when the slots are detected. This may properly align the drive mechanism with the rotor to align the rotor arms with the stator arms.

According to a first preferred embodiment of the indexing drive mechanism, there will be provided a drive plate which is associated with the rotor of the printing apparatus. The drive plate will typically be substantially circular in order to facilitate rotation. The drive plate is typically rotatably mounted about a central axis. One or more bearing means will generally be provided, usually both above and below the drive plate to ensure smooth rotation and also support of the drive plate, particularly that portion of the drive plate radially spaced from the central axis. These bearing means will usually also reduce friction during rotation and a particularly preferred form of bearing means is a ball bearing thrust race.

The drive plate is preferably mounted above the base of the printing apparatus and is operatively connected to the rotor so that the drive plate rotates with the rotor. The drive plate may be provided as a part of the rotor itself, or it may be separate from but attached relative thereto.

The drive plate will generally be provided with a first engagement means. The first engagement means will typically engage with a second engagement means in order to cause rotation of the drive plate. The first engagement means will typically be or include a plurality of extension portions extending from the drive plate. The extension portions are generally provided adjacent the circumference of the circular drive plate and are spaced about the circumference to scale according to the separation of the arm members extending from the rotor.

The extension portions will typically extend upward from an upper circular surface or depend from a lower circular surface of the drive plate, rather than extend radially outward from the drive plate. Each of the extension portions will typically be cylindrical with a longitudinal axis extending substantially perpendicularly to the drive plate and a radial dimension which is generally parallel to the drive plate.

Alternatively, the first engagement portion may be a plurality of openings formed in the circumference of the circular drive plate and spaced about the circumference to scale according to the separation of the arm members extending from the rotor. Each opening will typically extend radially outward from the central point of the drive plate.

The indexing drive mechanism of the first preferred embodiment will also typically include at least one engagement arm. The engagement arm will typically be separate from, but engageable with, the first engagement means provided on the drive plate. Typically only one engagement arm will be provided, with a first end and a second end. Generally, the engagement arm is rotatably mounted at the first end for rotation about the first end. The mounting of the engagement arm will typically be secured relative to the base of the printing apparatus to provide sufficient leverage to rotate the drive plate.

The second engagement means, as discussed above, will typically be located at or adjacent the second end of the engagement arm. The second engagement means will typically be configured to engage with the first engagement means. For example, when the first engagement means takes the form of a cylindrical extension portion, the second engagement means is typically a partially arcuate opening in the end of the engagement arm, and when the first engagement means is a plurality of radial openings in the drive plate, the second engagement means may include an extension portion to be received and at least temporarily engaged in the openings.

The engagement arm will typically be associated with a ram or similar means to facilitate controlled movement of the engagement arm. The ram will generally be a hydraulic or pneumatic ram. The ram is preferably adapted to extend and retract in a linear motion. One end of the ram is suitably attached to the engagement arm between the first end and the second end. An opposed end of the ram is suitably attached to a fixture point on the printing apparatus generally a location on the base spaced from the mounting of the engagement arm.

The movement of the drive plate by the indexing drive mechanism according to the first preferred embodiment involves the reciprocating movement of the second engagement means through an arcuate path. The engagement arm and second engagement means typically start in a substantially central position at the start of a movement cycle which coincides with alignment of the rotor and stator arms. The ram then preferably forces the engagement arm to move away or towards the fixture point depending upon the direction of rotation desired, through linear extension of the ram. Due to the configuration of the engagement arm, the second engagement means will disengage from the first engagement means at a particular point. The ram will then retract, rotating the engagement arm in the reverse direction until the second engagement means engages with the next spaced first engagement means on the drive plate. The ram then extends again to force the newly engaged first engagement means to the mid-point of the cycle where the rotor and stator arms are aligned.

According to a second preferred embodiment of the indexing drive mechanism, there will be provided a drive plate which is associated with the rotor of the printing apparatus. The drive plate will typically be substantially circular in order to facilitate rotation. The drive plate is typically rotatably mounted about a central axis. One or more bearing means will generally be provided, usually both above and below the drive plate to ensure smooth rotation and also support of the drive plate, particularly that portion of the drive plate radially spaced from the central axis. These bearing means will usually also reduce friction during rotation and a particularly preferred form of bearing means is a ball bearing thrust race.

The drive plate is preferably mounted above the base of the printing apparatus and is operatively connected to the rotor so that the drive plate rotates with the rotor. The drive plate may be provided as a part of the rotor itself, or it may be separate from but attached relative thereto.

The drive plate will generally be provided with a first engagement means. The first engagement means will typically engage with a second engagement means in order to cause rotation of the drive plate. The first engagement means may be a plurality of openings formed in the circumference of the circular drive plate and spaced about the circumference to scale according to the separation of the arm members extending from the rotor. Each opening will typically extend radially outward from the central point of the drive plate, and extend through the drive plate.

The indexing drive mechanism of the second preferred embodiment will also typically include at least one engagement arm. The engagement arm will typically be separate from, but engageable with, the first engagement means provided on the drive plate. Typically, only one engagement arm will be provided, with a first end and a second end. Generally, the engagement arm is rotatably mounted at the first end for rotation about the first end. The mounting of the engagement arm will typically be relative to the base of the printing apparatus to provide sufficient leverage to rotate the drive plate. The engagement arm typically rotates in a complete circle during a cycle of movement, engaging the drive plate during only a portion of the circular cycle.

The second engagement means as discussed above will typically be located at or adjacent the second end of the engagement arm. The second engagement means will typically be configured to engage with the first engagement means. The second engagement means is preferably an extension portion extending from the engagement arm.

The extension portion may typically extend upward from an upper surface or depend from a lower surface of the engagement arm, rather than extend axially outward from the engagement arm. The extension portion will typically be cylindrical with a longitudinal axis extending substantially perpendicularly to the engagement arm and a radial dimension which is generally parallel to the engagement arm.

The engagement arm is generally associated with a motor or similar means to drive the circular movement of the engagement arm. The motor is generally associated with the engagement arm but may not be connected directly to the arm. The motor will typically be provided with a drive train including a torque limiting means and a bearing means as well as the engagement arm. The drive train may also include a rotary encoder to control the movement and/or the position of the engagement arm.

Generally, the engagement arm will be driven through a sequence to move the rotor arms through print stations. The sequence will typically be repeatable as with the first preferred embodiment, but whereas the first preferred embodiment includes a reciprocating movement, the second includes a rotational movement.

There may also be a “home position” for the engagement arm, at which position the engagement arm is typically free of the drive plate to allow the free or manual rotation of the drive plate and/or rotor.

The movement of the drive plate by the indexing drive mechanism according to the second preferred embodiment involves the rotational movement of the second engagement means through a circular path. The engagement arm and second engagement means typically start the movement cycle in a position which coincides with alignment of the rotor and stator arms. The motor then preferably forces the engagement arm to rotate. Due to the configuration of the engagement arm and the second engagement means, the second engagement means will engage with the first engagement means on the drive plate and rotate the drive plate. The second engagement means remains engaged with the first engagement means during the rotation until the drive plate and engagement arm have rotated to a point where the second engagement means disengages from the first engagement means. The engagement arm will then continue rotating until the second engagement means either engages with the next spaced first engagement means on the drive plate, or until the home position is reached.

The above preferred embodiments are not the sole mechanisms which can be used.

The indexing that takes place may suitably be movement of the rotor through a particular arc length. The length of the arc may suitably be determined according to the number of arms extending from the stator or the rotor.

Suitably the drive mechanism may be capable of determining its position and additionally of returning to a predetermined position upon starting or restarting. This feature may allow the drive mechanism to return the rotor to its last position prior to stopping. This may allow the rotor to not lose time if it becomes jammed or stopped for any reason as the rotor can be returned to the last position prior to it stopping to resume the printing process.

Most preferably, there may be a torque limiter associated with the drive mechanism to allow the rotor to be stopped temporarily or for an extended period of time should anything impinge the rotor or become jammed in the rotor. If jamming should occur, the torque limiter may allow the rotor to be halted to prevent injury to any person or damage to the apparatus.

According to a further aspect of the present invention, there is provided a torque limiting assembly including a first torque plate having at least one opening therein and a second torque plate having at least one opening therein, and at least one bearing member located partially in the at least one opening in both first and second torque plates, the torque plates closely spaced from one another and biased into the closely spaced condition, such that the torque plates rotate together until a sufficiently large torque differential occurs between the plates causing the at least one bearing member to dislodge from the at least one opening and the plates to separate, one torque plate rotating freely with respect to the other.

The torque limiting assembly is typically mounted for rotation about a substantially vertical axis. This results in the first and second torque plates being configured as an upper and a lower torque plate. The lower plate is generally rotatably mounted in a fixed position and the upper plate is biased downwardly toward the lower plate. The biasing is typically accomplished through the provision of one or more biasing means, generally springs which are partially compressed or similar.

The upper plate is generally an annular member and is mounted for rotation through association with an axle member. The axle member is normally mounted co-axially with the lower torque plate.

The axle member preferably has a radially extending flange. The annular member is typically mounted in a spaced apart relationship with the radial flange and the spacing is typically maintained by the biasing means. The radial flange and the annular member are attached relative to one another usually using a plurality of bolts or similar spaced about the circumference of the flange and the biasing springs are typically located about the bolt members.

The lower torque plate generally rotates about a co-axial centre of rotation. The lower plate is typically an annular plate with an axle member integrally formed with the plate.

The at least one opening (of which there will generally be more than one) provided in the upper torque plate will generally be at least partially hemispherical or torispherical.

The at least one opening (of which there will generally be more than one) provided in the lower torque plate will generally be shaped circumferentially with a ramped side and a sheer side. (By sheer side it is intended to mean an unchanged hemispherical or torisphercial sidewall portion). Typically, the ramped side of the opening will be provided on a trailing side of the opening in the direction of normal rotation and the sheer side will be oriented on the leading edge of the opening in the direction of normal rotation. The ramped side includes a ramp surface which is suitably arcuate circumferentially and also tangentially. Preferably, the ramped side of the opening may have a low edge before the ramped surface.

There are typically a plurality of openings provided in each of the upper and lower torque plates and the openings are spaced circumferentially about the plates. Normally, the openings will be provided towards an outer portion of the plates.

There may be a circumferential channel provided in the lower plate which is offset (either inwardly or outwardly) from the openings so that once the bearing members have been dislodged from their respective openings, the bearings can rotate freely in the openings in the top plate and the channel of the lower plate until the torque limiting assembly is reset. Resetting of the assembly may be accomplished by rotating the rotor and the associated upper plate in the reverse direction until the bearing members are positioned in the openings in the lower plate.

There may also be provided retaining means to retain the bearing members in the openings in the upper torque plate when the plates are separated but still allow rotation of the bearing members within the opening.

There will generally be a plurality of bearing members provided, and each bearing member will normally have a shape to be closely received in the hemispherical or torispherical openings. Normally, the bearing members will be substantially spherical.

The torque limiting assembly of a particularly preferred embodiment will generally operate to transmit the rotational force of the motor to the engagement arm when small or normal differential torques are applied to the two plates. When this occurs, the plates rotate together. When a predetermined torque differential (“the limiting torque”) is applied to the two plates, the upper plate is deflected up against the biasing means and the lower plate, which continues to be driven by the motor, can rotate without imparting a significant rotational force on the upper plate. There may also be a sensor means provided so that when the upper plate is deflected upwardly, the motor may be disengaged to prevent damage to the motor.

The height of the sheer side of the opening in the lower torque plate will generally determine the magnitude of the limiting torque.

According to a further aspect of the present invention, there is provided stroke adjustment means for adjusting the stroke of a print head, the adjustment means comprising an arm member, an inner portion of which mounts the print head, means for setting the length of stroke required, a driving piston for driving the print head and limit or contact switches which provide a signal to a controller once the desired stroke has been made.

The arm member preferably is formed of a substantially hollow extrusion, wherein the mounting for the print head is located in the interior of the hollow extrusion and extends through longitudinally aligned openings in the wall of the extrusion. The mounting for the print head may then move backwards and forwards along the length of the arm. The mounting for the print head and therefore the print head itself may preferably be drivable along the length of the arm by a moving means. The moving means may preferably comprise a ram.

The arm members may suitably be formed from more than one portion of extrudate. It will have a generally rectangular cross-section. There will typically be a plurality of extrusions used to form an arm member, and the extrusions will be of two main types, namely side extrusion members and linking extrusions, generally located at the upper and lower sides of the arm member to link the side members. The assembled arm will typically be at least partially hollow in order to mount components of the printing head within the arm member.

The linking extrusions are generally H-shaped with a pair of spaced apart members and a cross-piece. The linking extrusion will generally be oriented in a sideways configuration with the cross-piece oriented substantially vertically. Located at or towards both ends of each of the spaced apart members will typically be a locking extension. The locking extensions will generally be provided on an inner side of the spaced apart members.

Each side extrusion will generally have a substantially U-shaped configuration with a sidewall and an upper and lower inwardly extending engagement wall. There will suitably be a longitudinally extending channel provided on both the upper and lower engagement wall to engage with the locking extrusions provided on the linking extrusions.

Both types of extrusion may be provided in any suitable length to form the arm members. Typically however, the side extrusions will be provided over the full length of the arm members. The linking extrusions may be provided only over one or more portions of the length of the arm member and the portions may be offset from one another in regard to the upper and lower linking extrusions. This will allow longitudinal openings to be formed in the arm to mount the print head, the limit switches and the like.

The limit or contact switches are preferably movable along the length of each arm in order to provide the length of stroke adjustment. These are preferably mounted on the upper side of the arm member so as not to obstruct the movement of the print head. There is typically a tapered member associated with the print head. The tapered member will typically extend in both ways from the print head, given that the print head will typically move backward and forwards along the arm, between a pair of limit switches.

The limit switch will generally be provided with a sensor means to detect the contact of the tapered member. The limit switches will typically be securable in position on the arm member using a clamp or some similar type of means to temporarily secure the position.

According to still a further aspect of the present invention, there is provided an attachment means for attaching a support assembly such as an arm member, to a supported member such as a workpiece support plate, the attachment means having at least one tapered opening on either the support assembly or the supported member and a tapered attachment member adapted to be received in the at least one opening and secured therein, on the other of the support assembly or the supported member.

According to this aspect of the invention, the supported member will typically be a workpiece support plate provided with the rotor arms of the printing apparatus. The support assembly is generally a support plate attached to an outer end of a rotor arm of the printing apparatus.

The support plate will generally be an elongate plate which is securely attached to the rotor arm. It will generally be provided with at least one tapered opening at each end and generally a pair of openings will be provided at each end, one on either side of a mid-line of the support plate. Preferably, the support plate overlaps the width of the support arm laterally a small distance generally between 1 and 5 cm per side, such that when the workpiece support plate is removed, access to the centre of the printing apparatus is convenient.

Each of the tapered openings will preferably possess the same shape. Each tapered opening will preferably have a V-shape when viewed from above with the apex of the V-shaped opening oriented inwardly from the end of the support plate. Each opening will also typically have a wedge shape when viewed from the side.

The attachment member is normally associated with the workpiece support plate and generally a pair of attachment members will be provided at each end of the workpiece support plate to each engage with an opening provided in the support plate. Each attachment member will typically be substantially cylindrical with a conical end portion. The attachment members are normally mounted approximately parallel to the workpiece support plate. The attachment portions will normally be associated with a threaded member to adjust and/or fix the position of the attachment member. Normally, the threaded member will be mounted perpendicularly to the attachment member so that the attachment member can be moved toward or away from the workpiece support plate. The threaded members may be mounted through the workpiece support plate.

To attach the workpiece support plate to the support plate, one end is normally engaged first by locating the tapered attachment members of a first end of the workpiece support platform in the tapered opening provided on the support plate at that end. The second end of the workpiece support plate is then lowered onto the support plate. The attachment members of the second end can then be tightened using the threaded members and this not only fixes the workpiece support plate to the support plate, but due to the shape of the openings and the tapered nature of the attachment member, tightening the attachment member will also assist with the levelling and correct orientation of the workpiece support plate.

According to a still further aspect of the present invention, there is provided means for raising and lowering the rotor relative to the stator which is adjustable including at least one piston for driving a rocker arm which is in contact with the underside of the locating plate, a forward stroke of the piston resulting in the rotor rising and a rearward stroke resulting in the rotor lowering.

The pistons may be associated with the locating plate in a vertical orientation. However it is preferred that the pistons be inclined at an angle to the locating plate as the distances through which the locating plate must travel are often not large and inclining the pistons may allow a greater ability for fine adjustment.

The length of the stroke of the pistons may preferably be adjustable. As can be appreciated, adjusting the length of the stroke of the pistons may adjust the amount that the rotor may be raised or lowered.

The length of the stroke of the pistons may preferably be manually adjustable.

According to a still further aspect of the present invention, there is provided a carousel screen printing apparatus in which at least a portion of the stator arms can be tilted to facilitate the use of portable drying devices for drying newly printed articles.

The drying devices may preferably be simple air blowers or they may also suitably be heaters. The dryers additionally may typically not have air blowers at all and be only flash heaters.

The stator of the carousel will generally include a plurality of radially extending arm members. Each arm member will generally be provided with a print head assembly at or adjacent an outer end of the arm member. The print head assembly generally mounts all apparatus to accomplish the printing and even the screens used can be mounted relative to the print head assembly.

Typically, the print head assembly will be associated with the arm member by a pivoting arrangement. One or more springs or hydraulic rams may be provided to facilitate or assist with the lifting of the print head. Generally, the print head may be provided with a pair of opposed springs or similar, one in tension and one in compression, which can be adjusted to achieve and maintain the print head in a working position. The opposed springs may be similar to opposed muscles in an anatomical sense. There may be a locking mechanism provided to at least temporarily lock the print head in the working position.

There may also be a free position for the print head in which the print head and all components mounted thereto can be tilted upwardly away from the workpiece support and rotor assembly. Suitably, only the outer portion of the arm which mounts the print head is tilted.

The print head on one or more of the arms may be oriented in the free position during the printing cycle so that dryers may be used to dry one layer of print prior to the application of another subsequent layer.

### BRIEF DESCRIPTION OF THE DRAWINGS

Aspects of the present invention will now be described with reference to the accompanying drawings in which;

FIG. 1 is a top view of a screen printing apparatus according to a preferred embodiment of the present invention with some of the stator arm print heads removed.

FIG. 2 is a sectional side view of the screen printing apparatus illustrated in FIG. 1 with one of the print heads shown in dotted outline in a raised position.

FIG. 3 is a top view of an indexing drive mechanism according to a first preferred embodiment of the present invention.

FIG. 4 is a sectional side view of the indexing drive mechanism illustrated in FIG. 3.

FIG. 5 is a top view of an indexing drive mechanism according to a second preferred embodiment of the present invention.

FIG. 6 is a sectional side view of the indexing drive mechanism illustrated in FIG. 5.

FIG. 7 is a sectional side view of a print head portion of a preferred embodiment of the present invention with a print head shown in dotted outline in a raised position.

FIG. 8 is a top view of a mounting plate for mounting a print board (not shown) relative thereto according to a preferred embodiment of the present invention.

FIG. 9 is an end view of the mounting plate and support arm illustrated in FIG. 8.

FIG. 10 is a sectional side view of the mounting plate and support arm illustrated in FIG. 9.

FIG. 11 is a bottom view of a print board to be mounted relative to the mounting plate according to a preferred embodiment of the present invention.

FIG. 12 is an end view of the mounting plate and support arm illustrated in FIG. 8.

FIG. 13 is a sectional side view of the mounting plate and support arm with the print board mounted thereon. according to a preferred embodiment of the present invention.

FIG. 14 is a detailed sectional side view of the print board mounting and adjustment mechanism according to a preferred embodiment of the present invention.

FIG. 15 is a sectional end view of a stator arm with limit switch means and adjustable print means according to a preferred embodiment of the present invention.

FIG. 16 is a sectional end view of an assembled arm member according to a preferred embodiment of the present invention.

FIG. 17 is a sectional end view of an extruded side member for the arm member according to a preferred embodiment of the present invention.

FIG. 18 is a sectional end view of an extruded top member for the arm member according to a preferred embodiment of the present invention.

FIG. 19 is a schematic side view of an opening formed in a lower torque plate according to a preferred embodiment of the present invention.

FIG. 20 is a sectional side view of a torque limiting assembly according to a preferred embodiment of the present invention.

FIG. 21 is a top view of a lower torque plate according to a preferred embodiment of the present invention.

### DESCRIPTION OF THE PREFERRED EMBODIMENT

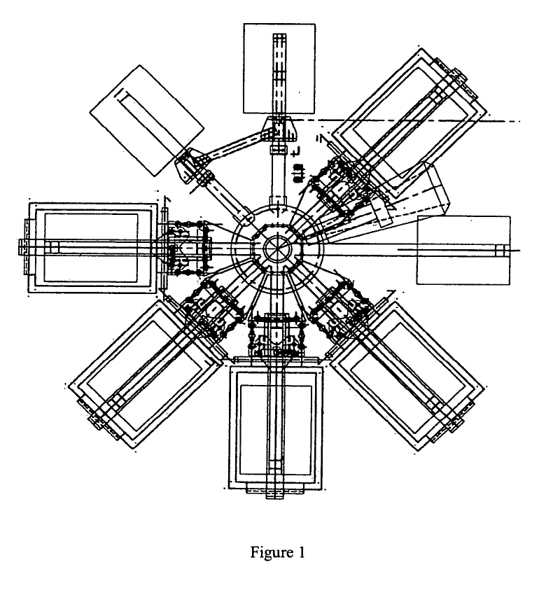

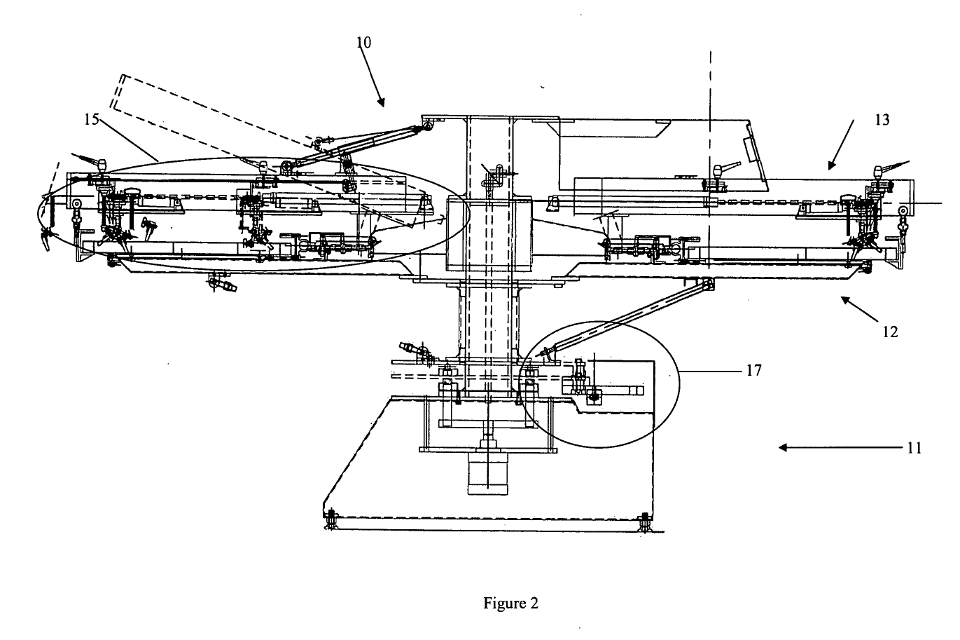

With respect to the drawings, a preferred embodiment of the carousel screen printer according to the present invention is illustrated generally in FIGS. 1 and 2. The screen printer 10 as illustrated comprises a base generally indicated by arrow 11, a rotor generally indicated by arrow 12 and a stator generally indicated by arrow 13.

The stator 13 has a plurality of radially extending arms 14 operatively connected to the base 11 and each arm mounts a print head 15. The rotor also has a plurality of radially extending arms 14 operatively connected to the base 11 and each arm mounts a workpiece support assembly 16. The rotor 12 is associated with an indexing drive mechanism 17 for driving and indexing the rotor 12 with respect to the stator 13.

As illustrated in FIGS. 1 and 2, the screen printer 10 according to the preferred embodiment is a carousel-type screen printer having a number of print stations spaced circumferentially about a vertical axis, a rotor 12 mounting an equal number of workpiece supports 16, or pallets, also spaced circumferentially about the axis, and a drive mechanism 17 for rotating the rotor 12 to align the pallets 16 with the print stations 15 in succession. Each pallet 16 is elevated to and lowered from a raised printing position at each print station 15. Each print station includes a print head 15 with a screen frame 18 mounting a printing screen 19 having blocked and unblocked screen apertures or pores defining an image to be printed. Each print station also includes a so-called print or flood bar 20 movable back and forth across the upper side of the screen 19 for spreading a printing ink across the screen 19 and forcing the ink through the open screen pores. The images on the several printing screens define different portions or colour separations of a completed multicolour image to be printed.

Operation of a carousel screen printer 10 involves (a) mounting a workpiece to be imprinted on each work pallet 16, (b) rotating the printer rotor 12 stepwise through its successive printing positions to rotate the work pallets 16 to the print stations in succession, (c) elevating the pallets 16 at the successive print stations to their printing positions in which the workpieces on the pallets 16 contact the undersides of the respective printing screens 19, and (d) driving the squeegee and flood bars 20 back and forth across the upper sides of their respective screens 19 while the pallets 16 are in their elevated printing positions to imprint the respective screen images on the workpieces. The several screen images are thereby imprinted in succession on each workpiece. Each of these several screen images is printed in a different single colour. The shapes of the several screen images and the different colours in which these images are successively imprinted on each workpiece are selected to produce on each workpiece a desired composite multicolour image.

There may be a printing head 15 associated with each of the extending arms 14 of the stator 13 towards an outward end thereof. The indexing drive mechanism 17 rotates the rotor 12 relative to the stator 13 and also aligns the rotor 12 and stator 13 arm members 14 to ensure high print quality.

The pallets 16 are moved in a controlled manner around the apparatus 10 and aligned with the printing head 15 provided on at least some of the stator arms 14.

The rotor 12 is capable of being raised or lowered. The raising or lowering is accomplished by a means for raising and lowering.

There are at least two preferred embodiments of the indexing drive mechanism 17.

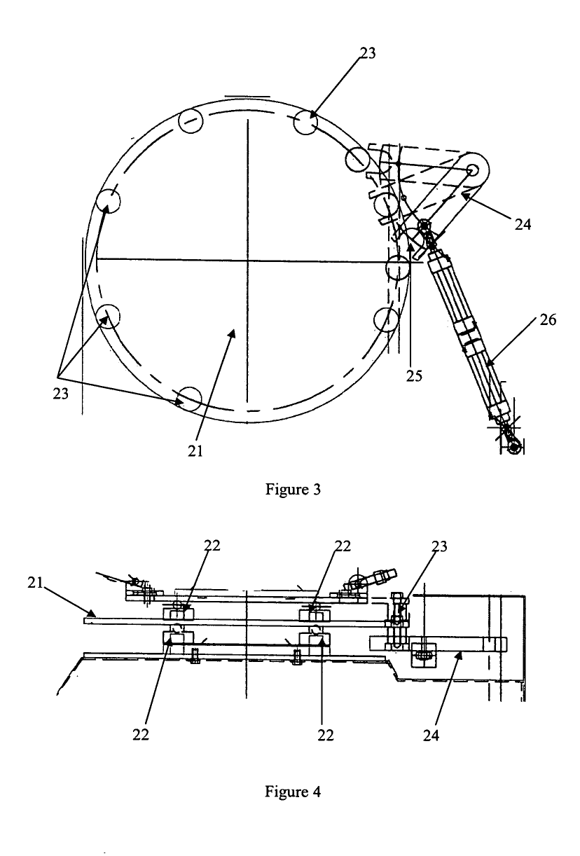

According to a first preferred embodiment of the indexing drive mechanism 17 as illustrated in FIGS. 3 and 4, a drive plate 21 is provided which is associated with the rotor 12 of the printing apparatus 10. The drive plate 21 is substantially circular in order to facilitate rotation and rotatably mounted about a central axis. One or more bearings 22 are provided, usually both above and below the drive plate 21, to ensure smooth rotation and also support of the drive plate 21, particularly the outer portion of the drive plate 21 radially spaced from the central axis. The bearings 22 also reduce friction during rotation and a particularly preferred form of bearing is a ball bearing thrust race.

The drive plate 21 is mounted above the base 11 of the printing apparatus 10 and is operatively connected to the rotor 12 so that the drive plate 21 rotates with the rotor 12.

The drive plate 21 is provided with a plurality of extension portions 23 extending from the drive plate 21. The extension portions 23 are provided adjacent the circumference of the circular drive plate 21 and are spaced about the circumference to scale, according to the separation of the arm members 14 extending from the rotor 12.

The extension portions 23 depend from a lower circular surface of the drive plate 21. Each of the extension portions 23 is cylindrical with a longitudinal axis extending substantially perpendicularly to the drive plate 21 and a radial dimension which is generally parallel to the drive plate 21.

The indexing drive mechanism 17 of the first preferred embodiment also includes an engagement arm 24. The engagement arm 24 is separate from, but engageable with, the extension portions 23 provided on the drive plate 21. The engagement arm 24 has a first end and a second end. The engagement arm 24 is rotatably mounted at the first end for rotation about the first end. The mounting of the engagement arm 24 is attached relative to the base 11 of the printing apparatus 10 to provide sufficient leverage to rotate the drive plate 21.

A partially arcuate opening 25 is provided in the second end of the engagement arm 24 to engage with the extension portions 23 to rotate the drive plate 21.

The engagement arm 24 is associated with a hydraulic ram 26 to facilitate controlled movement of the engagement arm 24. The ram 26 is adapted to extend and retract in a linear motion. One end of the ram 26 is attached to the engagement arm 24 between the first end and the second end. An opposed end of the ram 26 is attached to a fixture point on the printing apparatus 10, generally a location on the base 11, spaced from the mounting of the engagement arm 24.

The movement of the drive plate 21 by the indexing drive mechanism 17 according to the first preferred embodiment involves the reciprocating movement of the engagement arm 24 and the arcuate opening 25 in particular through an arcuate path. The engagement arm 24 and opening 25 typically start in a substantially central position at the start of a movement cycle which coincides with alignment of the rotor 12 and stator 13 arms. The ram 26 then forces the engagement arm 24 to move away from the fixture point through linear extension of the ram 26. Due to the configuration of the engagement arm 24, the opening 25 will disengage from the extension portion 23 at a particular point. The ram 26 then retracts, rotating the engagement arm 24 in the reverse direction until the arcuate opening 25 engages with the next extension portion 23 on the drive plate 21. The ram 26 then extends again to force the newly engaged extension portion 23 to the mid-point of the cycle where the rotor 12 and stator 13 arms are aligned.

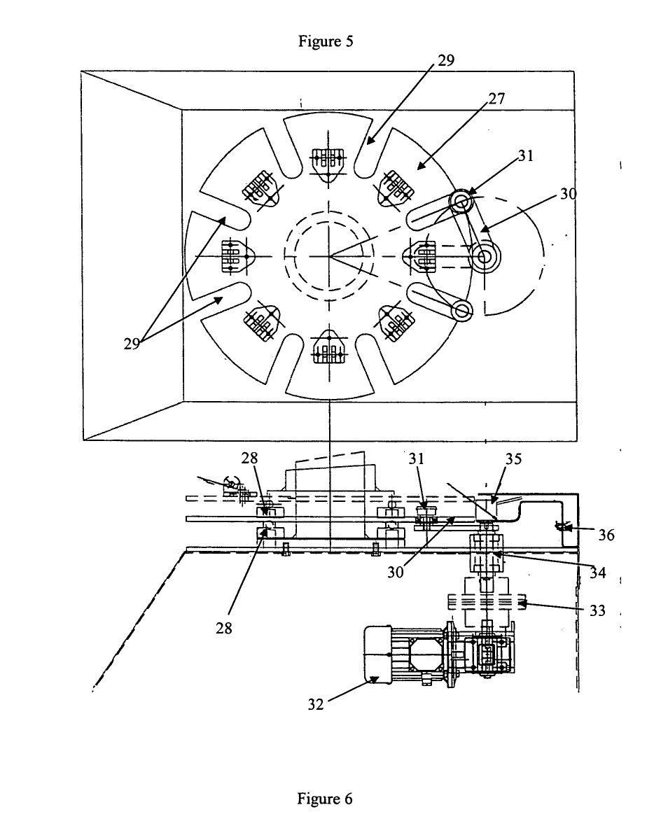

According to a second preferred embodiment of the indexing drive mechanism 17 as illustrated in FIGS. 5 and 6, there is provided a drive plate 27 which is associated with the rotor 12 of the printing apparatus 10. The drive plate is substantially circular in order to facilitate rotation and is rotatably mounted about a central axis. One or more bearings 28 are provided, usually both above and below the drive plate 27, to ensure smooth rotation and also support the drive plate 27, particularly the portion of the drive plate 27 radially spaced from the central axis. The bearings 28 will usually also reduce friction during rotation and a particularly preferred form of bearing 28 is a ball bearing thrust race.

The drive plate 27 is mounted above the base 11 of the printing apparatus 10 and is operatively connected to the rotor 12 so that the drive plate 27 rotates with the rotor 12.

The drive plate 27 is provided with a first engagement means in the form of plurality of slotted openings 29 which engage with a second engagement means in order to cause rotation of the drive plate 27. Each of the plurality of openings 29 formed in the circumference of the circular drive plate 27 are spaced about the circumference to scale according to the separation of the arm members 14 extending from the rotor 12. Each opening 29 extends radially outward from the central point of the drive plate 27 and extend through the drive plate 27.

The indexing drive mechanism 17 of the second preferred embodiment also includes an engagement arm 30 with a first end and a second end. The engagement arm 30 is separate from, but engageable with, the openings 29 provided on the drive plate 27. The engagement arm 30 is rotatably mounted at the first end for rotation about the first end. The mounting of the engagement arm 30 is relative to the base 11 of the printing apparatus 10 to provide sufficient leverage to rotate the drive plate 27. The engagement arm 30 of this embodiment rotates in a complete circle during a cycle of movement, engaging the drive plate 27 during only a portion of the circular cycle.

The second engagement means as discussed above is located at or adjacent the second end of the engagement arm 30 and is an extension portion 31 extending from the engagement arm 30.

The extension portion 31 extends upwardly from an upper surface of the engagement arm 30. The extension portion 31 is cylindrical with a longitudinal axis extending substantially perpendicularly to the engagement arm 30 and a radial dimension which is generally parallel to the engagement arm 30.

The engagement arm 30 is associated with a motor 32 to drive the circular movement of the engagement arm 30. The motor 32 is not connected directly to the arm 30. The motor 32 is provided with a drive train including a torque limiting assembly 33 and a bearing 34 as well as the engagement arm 30. The drive train is associated with a rotary encoder 35 to control the movement and/or the position of the engagement arm 30.

The engagement arm 30 is driven through a sequence to move the rotor 12 arms through print stations. The sequence is repeatable as with the first preferred embodiment, but whereas the first preferred embodiment includes a reciprocating movement, the second includes a rotational movement.

There is also a “home position” 36 for the engagement arm 30, at which position the engagement arm 30 is free of the drive plate 27 to allow the free or manual rotation of the drive plate 27 and/or rotor 12.

The movement of the drive plate 27 by the indexing drive mechanism 17 according to the second preferred embodiment involves the rotational movement of the engagement arm 30 and particularly the extension portion 31 through a circular path. The engagement arm 30 and extension portion 31 start the movement cycle in a position which coincides with alignment of the rotor 12 and stator 13 arms. The motor 32 then forces the engagement arm 30 to rotate. Due to the configuration of the engagement arm 30 and the openings 29 in the drive plate 27, the extension portion 31 engages with the opening 29 on the drive plate 27 and rotates the drive plate 27. The extension portion 31 remains engaged with the opening 29 during the rotation until the drive plate 27 and engagement arm 30 have rotated to a point where the extension portion 31 disengages from the opening 29. The engagement arm 30 then continues rotating until the extension portion 31 either engages with the next spaced opening 29 on the drive plate 27, or until the home position 36 is reached.

Each embodiment also includes a sensor so that the indexing drive mechanism 17 is capable of proper alignment with the rotor 12. According to a preferred embodiment, the sensor means includes a tube or similar associated with the rotor 12, the tube having a plurality of radially spaced slots or openings therein. The sensor can detect the slots on the tube and control the indexing drive mechanism 17 to engage the rotor 12 when the slots are detected to properly align the drive mechanism 17 with the rotor 12 to align the rotor arms 14 with the stator arms 14.

The indexing that takes place is movement of the rotor 12 though a particular arc length, the length of the arc determined according to the number of arms 14 extending from the stator 13 or the rotor 12.

There is a torque limiter 33 associated with the drive mechanism 17 to allow the rotor 12 to be stopped temporarily or for an extended period of time should anything impinge the rotor 12 or become jammed between the rotor arms and the stator arms. If jamming should occur, the torque limiter 33 allows the rotor 12 to be halted to prevent injury to any person or damage to the apparatus 10.

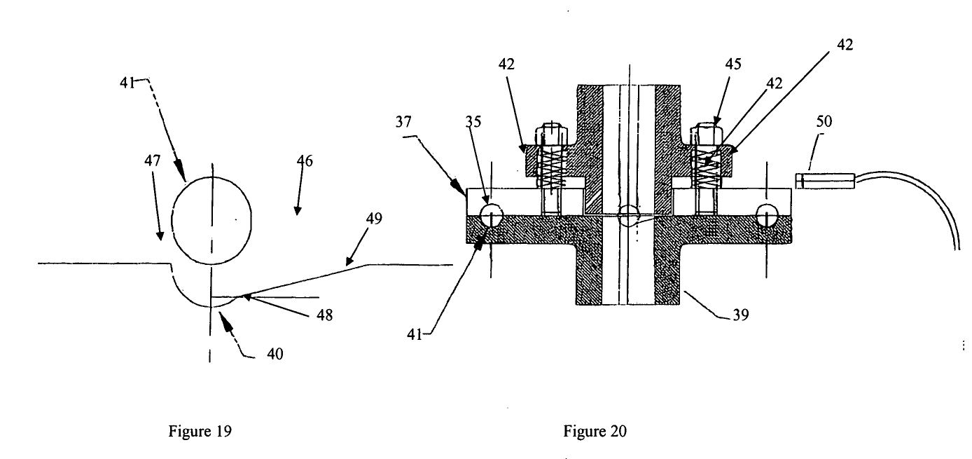

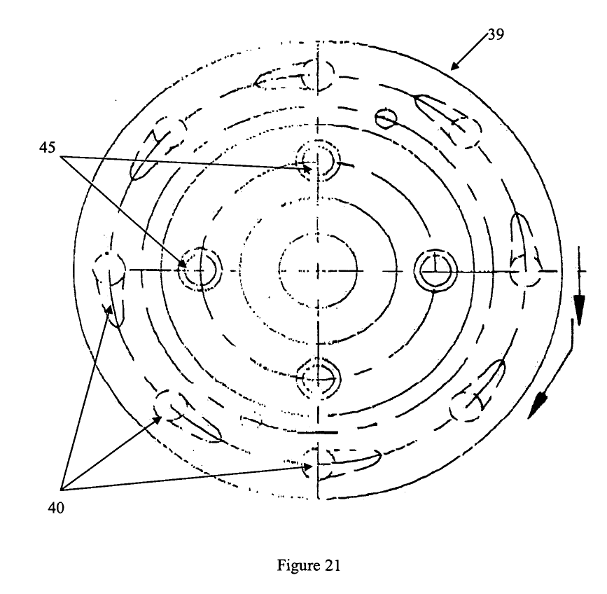

The preferred embodiment of torque limiter 33 as illustrated in FIGS. 19 to 21 includes an upper torque plate 37 having a plurality of openings 38 therein and a lower torque plate 39 having a plurality of openings 40 therein. A bearing member 41 is located partially in the aligned openings in both upper 37 and lower 39 torque plates. The torque plates 37, 39 are closely spaced from one another and biased into the closely spaced condition, such that the torque plates rotate together until a sufficiently large torque differential occurs between the plates causing the bearings 41 to dislodge from the openings 40 and the plates to separate so that the upper torque plate 37 can rotate freely with respect to the lower torque plate 39.

The torque limiting assembly 33 is mounted for rotation about a substantially vertical axis. The lower plate 39 is rotatably mounted in a fixed position and the upper plate 37 is biased downwardly toward the lower plate 39. The biasing is accomplished through the provision of one or more springs 42 which are partially compressed.

The upper plate 37 is an annular member and is mounted for rotation through association with an axle member 43. The axle member 43 is mounted co-axially with the lower torque plate 39.

The axle member 43 has a radially extending flange 44. The upper plate 37 is mounted in a spaced apart relationship with the radial flange 44 and the spacing is maintained by the springs 42. The radial flange 44 and the upper plate 37 are attached relative to one another using a plurality of bolts 45 spaced about the circumference of the flange 44 and the biasing springs 42 are located about the bolts 45.

The lower torque plate 39 rotates about a co-axial centre of rotation. The lower plate 39 is an annular plate with an axle member integrally formed with the plate.

The openings 38 provided in the upper torque plate 37 are at least partially hemispherical or torispherical.

The openings 40 provided in the lower torque plate 39 are shaped circumferentially with a ramped side 46 and a sheer side 47. (By sheer side it is intended to mean an unchanged hemispherical or torispherical sidewall portion). The ramped side 46 of each opening 40 will be provided on a trailing side of the opening 40 in the direction of normal rotation and the sheer side 47 will be oriented on the leading edge of the opening 40 in the direction of normal rotation. The ramped side 46 includes a ramp surface 49 which is arcuate circumferentially and also tangentially. The ramped side 46 of the opening 40 also has a low edge 48 before the ramped surface 49.

There are plurality of bearing members 41 provided and each bearing member 41 will have a shape to be closely received in the hemispherical or torispherical openings. Normally, the bearing members 41 will be substantially spherical.

The torque limiting assembly 33 of the preferred embodiment operates to transmit the rotational force of the motor 32 to the engagement arm 30 when small or normal differential torques are applied to the two plates 37, 39. When this occurs, the plates rotate together. When a predetermined torque differential (“the limiting torque”) is applied to the two plates, the upper plate 37 is deflected up against the biasing springs 42 and the lower plate 39, which continues to be driven by the motor 32, can rotate without imparting a significant rotational force on the upper plate 37. There is also be a sensor means 50 provided so that when the upper plate 37 is deflected upwardly, the motor 32 is disengaged to prevent damage to the motor 32.

The height of the sheer side 47 of the opening 40 in the lower torque plate 39 will generally determine the magnitude of the limiting torque.

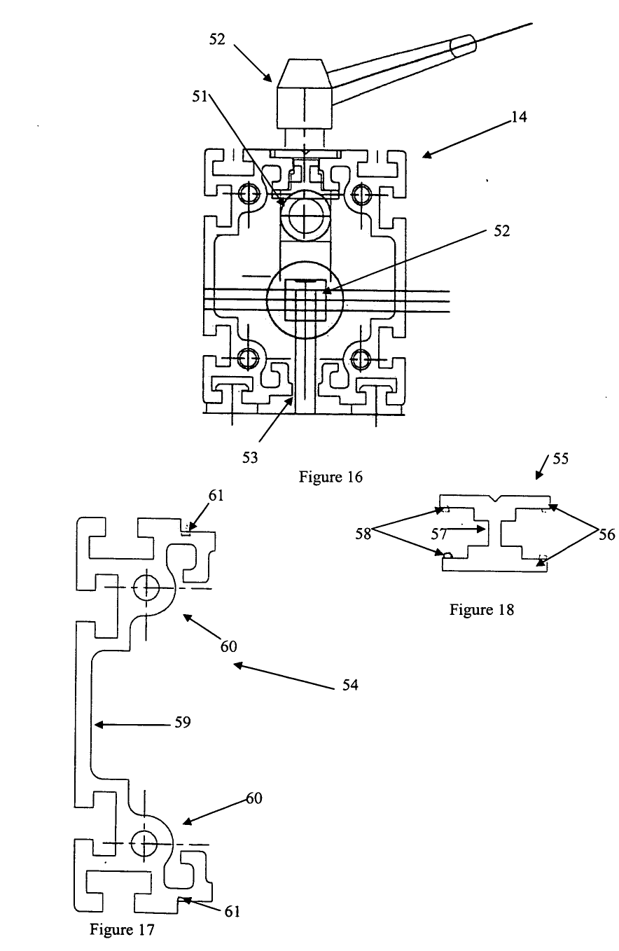

There is also provided stroke adjustment means, a preferred embodiment of which is illustrated in FIGS. 15 and 16 for adjusting the stroke of a print head 15. The adjustment means includes an arm member 14, an inner portion of which mounts the print head 15, limit or contact switches 51 for setting the length of stroke required by providing a signal to a controller once the desired stroke has been made, and a driving piston 52 for driving the print head 15.

The arm member 14 is formed of a substantially hollow extrusion, wherein the mounting for the print head 15 is located in the interior of the hollow extrusion and extends through longitudinally aligned openings 53 in the wall of the extrusion. The mounting for the print head 15 can move backwards and forwards along the length of the arm 14. The print head 5 is drivable along the length of the arm by ram or piston 52.

The arm members 14 are formed from more than one portion of extrudate and have a generally rectangular cross-section. There will typically be a plurality of extrusions used to form an arm member 14, and the extrusions will be of two main types, namely side extrusion members 54 (illustrated in FIG. 17) and linking extrusions 55 (illustrated in FIG. 18), generally located at the upper and lower sides of the arm member 14 to link the side members 54.

The linking extrusions 55 are generally H-shaped with a pair of spaced apart members 56 and a cross-piece 57. The linking extrusion 55 are oriented in a sideways configuration with the cross-piece 57 oriented substantially vertically as seen in FIG. 16. Located towards both ends of each of the spaced apart members 56 are locking extensions 58. The locking extensions 58 are provided on an inner side of the spaced apart members 56.

Each side extrusion 54 has a substantially U-shaped configuration with a sidewall 59 and an upper and lower inwardly extending engagement wall 60. There is a longitudinally extending channel 61 provided on both the upper and lower engagement wall 60 to engage with the locking extrusions 58 provided on the linking extrusions 55.

Typically, the side extrusions 54 will be provided over the full length of the arm members. The linking extrusions 54 are provided only over one or more portions of the length of the arm member 14. This will allow longitudinal openings 53 to be formed in the arm to mount the print head 15 and the limit switches 51.

The limit or contact switches 51 are movable along the length of each arm 14 in order to provide the length of stroke adjustment. The limit switches are mounted on the upper side of the arm member 14 so as not to obstruct the movement of the print head 15. The limit switches 51 are securable in position on the arm member 14 using a clamp 62 to temporarily secure the position.

FIG. 15 shows the mechanism by which the flood bar 20 is located within the extruded arm 14. It also shows that the flood bar 20 has a pair of fine adjustment screws 69 located on either side of the flood bar 20 to allow a user to adjust the distance between the flood bar 20 and the screen (not shown).

In FIG. 16, a limit switch 51 is shown, which is used to send signals to a controller to identify when the flood bar 20 has reached its limits. The limit is reached when the carriage trigger abuts the rest which is spring-loaded to prevent damage to the device. The limit switch 51 may be positioned using the clamp 52 to secure its position.

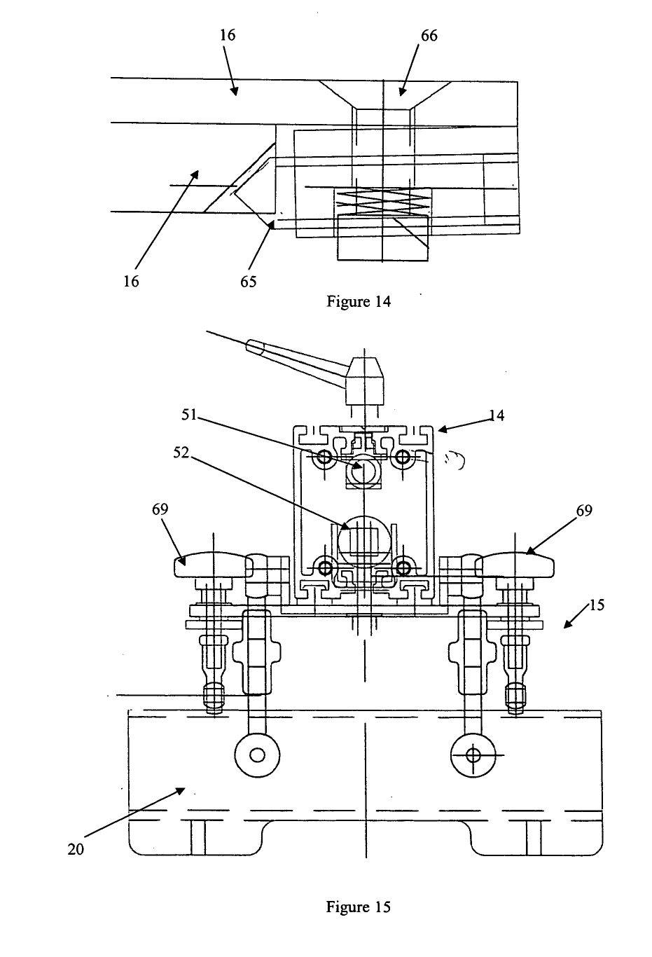

There is also provided an attachment means for attaching a workpiece support plate or pallet 16 to an arm member 14. The attachment means illustrated in FIG. 14 has a tapered opening 63 on a support plate 64 attached to an outer end of a rotor arm 14 of the printing apparatus 10 and a tapered attachment member 65 adapted to be received in the opening 63 on the workpiece support plate or pallet 16.

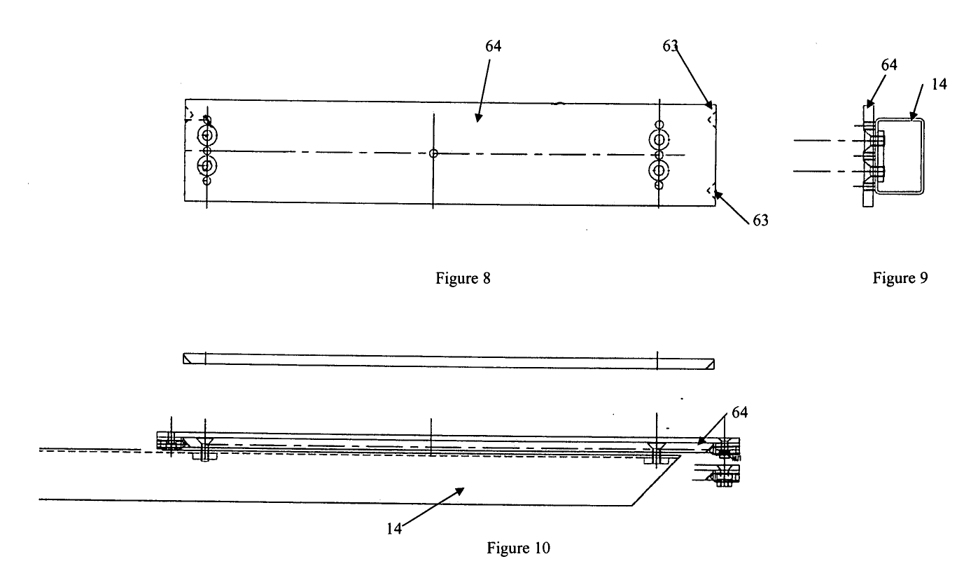

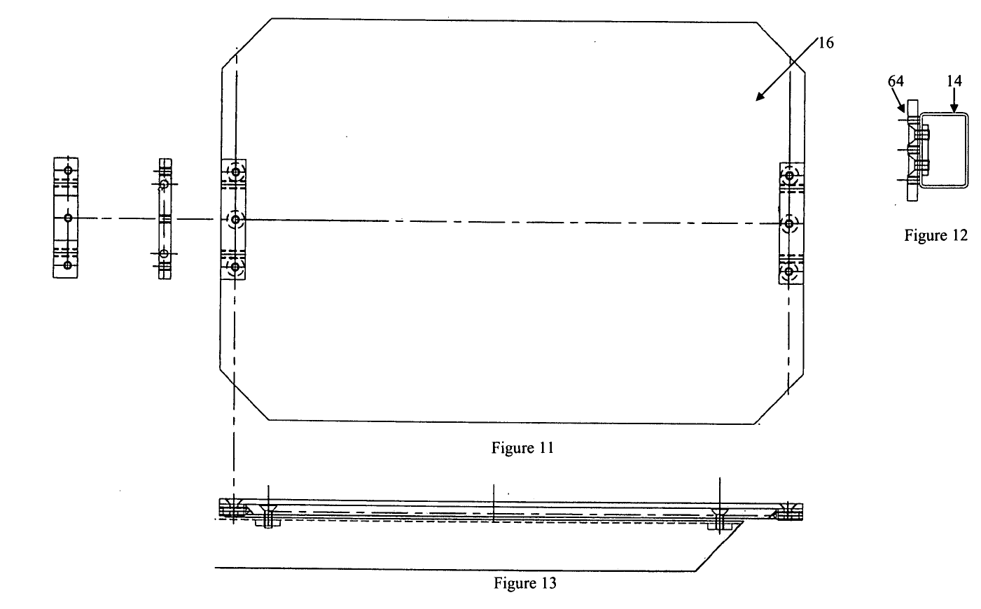

The support plate 64 is an elongate plate which is securely attached to the rotor arm 14 as illustrated in FIG. 8. It is provided with a pair of tapered openings 63 at each end, one on either side of a mid-line of the support plate 64. The support plate 64 overlaps the width of the support arm 14 laterally a small distance generally between 1 and 5 cm per side, such that when the workpiece support plate 16 is removed, access to the centre of the printing apparatus 10 is convenient.

Each of the tapered openings 63 possesses the same shape. Each tapered opening 63 has a V-shape when viewed from above with the apex of the V-shaped opening oriented inwardly from the end of the support plate 64. Each opening 63 also has a wedge shape when viewed from the side.

The tapered attachment member 65 is associated with the workpiece support plate 16 and a pair of attachment members 65 is provided at each end of the workpiece support plate 16 to each engage with an opening 63 provided in the support plate 64. Each attachment member 65 is substantially cylindrical with a conical end portion as illustrated in FIG. 14. The attachment members 65 are mounted approximately parallel to the workpiece support plate 16. The attachment members 65 are associated with a threaded member 66 to adjust and/or fix the position of the attachment member 65. Normally, the threaded member 66 is mounted perpendicularly to the attachment member 65 so that the attachment member 65 can be moved toward or away from the workpiece support plate 16. The threaded members 66 are mounted through the workpiece support plate 16.

To attach the workpiece support plate 16 to the support plate 63, one end is normally engaged first by locating the tapered attachment members 65 of a first end of the workpiece support platform 16 in the tapered opening 63 provided on the support plate 63 at that end. The second end of the workpiece support plate 16 is then lowered onto the support plate 63. The attachment members 65 of the second end can then be tightened using the threaded members 66 and this not only fixes the workpiece support plate 16 to the support plate 64, but due to the shape of the openings and the tapered nature of the attachment member 65, tightening the attachment member 65 will also assist with the levelling and correct orientation of the workpiece support plate 16.

According to a still further aspect of the present invention, there is provided means for raising and lowering the rotor relative to the stator which is adjustable including at least one piston for driving a rocker arm which is in contact with the underside of the locating plate, a forward stroke of the piston resulting in the rotor rising and a rearward stroke resulting in the rotor lowering.

The pistons may be associated with the locating plate in a vertical orientation. However it is preferred that the pistons be inclined at an angle to the locating plate as the distances through which the locating plate must travel are often not large and inclining the pistons may allow a greater ability for fine adjustment.

The length of the stroke of the pistons may preferably be adjustable. As can be appreciated, adjusting the length of the stroke of the pistons may adjust the amount that the rotor may be raised or lowered.

The length of the stroke of the pistons may preferably be manually adjustable.

At least a portion of the stator arms 14 can be tilted to facilitate the use of portable drying devices for drying newly printed articles.

The drying devices may be simple air blowers or they could be heaters. The dryers additionally may typically not have air blowers at all and be only flash heaters.

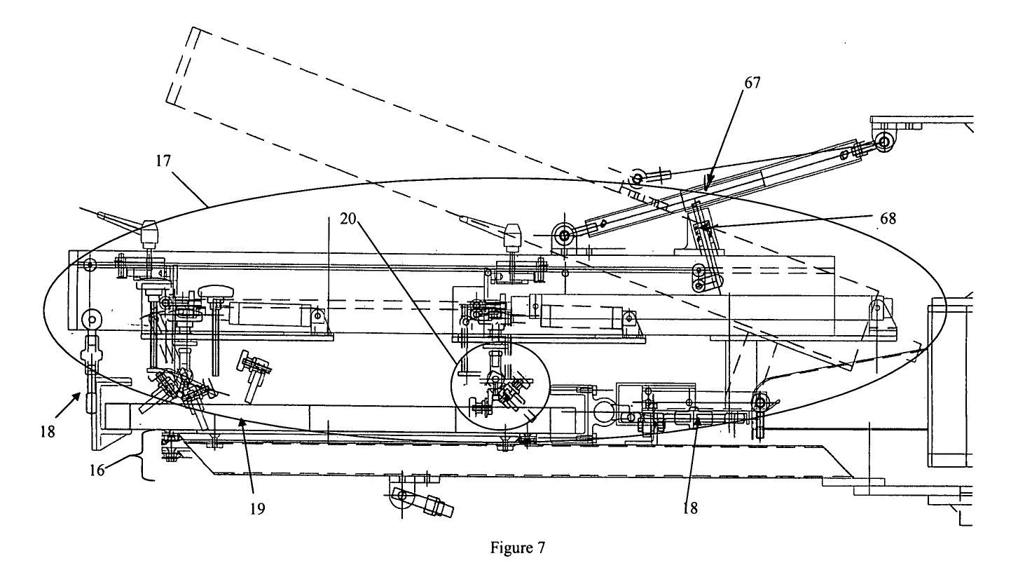

The stator 13 of the carousel as illustrated in FIG. 7 include a plurality of radially extending arm members 14. Each arm member 14 has a print station on an outer end of the arm member 14. The print station mounts all apparatus to accomplish the printing and even the screens 19 used can be mounted relative to the print station.

Typically, the actual print head 15 is associated with the arm member 14 by a pivoting arrangement. One or more springs are provided to facilitate or assist with the lifting of the print head 15. The print head 15 is provided with a pair of opposed springs or similar, one in tension 67 and one in compression 68, which can be adjusted to achieve and maintain the print head 15 in a working position.

There is also be a free position (illustrated in FIG. 8 in dotted outline) for the print head 15 in which the print head 15 and all components mounted thereto can be tilted upwardly away from the workpiece support 16 and rotor 12. Only the outer portion of the arm 14 which mounts the print head 15 is tilted.

The print head 15 on one or more of the arms 14 can be oriented in the free position during the printing cycle so that dryers may be used to dry one layer of print prior to the application of another subsequent layer.

Aspects of the present invention have been described by way of example only and it will be appreciated that modifications and additions thereto may be made without departure from the spirit or scope thereof.

1. A screen printing apparatus having a base, a stator having a plurality of radially extending arms operatively connected to the base, a rotor having a plurality of radially extending arms operatively connected to the base, and a indexing drive mechanism for driving and indexing the rotor with respect to the stator, the drive mechanism including at least one link arm adapted to, engage the engagement means of the rotor and control means to provide segmented movement of the rotor.

2. A screen printing apparatus according to claim 1 further including a printing device associated with each of the extending arms of the stator, generally towards an outward end thereof.

3. A screen printing apparatus according to claim 2 wherein the indexing drive mechanism rotates the rotor relative to the stator and also aligns the rotor and stator arm members.

4. A screen printing apparatus according to claim 1 wherein the stator or the rotor is capable of being raised or lowered.

5. A screen printing apparatus according to claim 2 wherein the indexing drive mechanism includes a sensor means so that the indexing drive mechanism is capable of proper alignment with the rotor.

6. A screen printing apparatus according to claim 1 wherein the indexing drive mechanism includes a drive plate which is associated with the rotor of the printing apparatus provided with a first engagement means, and a second engagement means mounted separately from the drive plate in order to cause rotation of the drive plate.

7. A screen printing apparatus according to claim 6 wherein the first engagement means includes extension portions with a longitudinal axis extending substantially perpendicularly to the drive plate and a radial dimension which is generally parallel to the drive plate.

8. A screen printing apparatus according to claim 6 wherein the first engagement means includes a plurality of openings formed in a circumference of the drive plate and spaced about the circumference to scale according to the separation of the arm members extending from the rotor.

9. A screen printing apparatus according to claim 6 wherein the second engagement means, is provided on an engagement arm member and is configured to engage with the first engagement means.

10. A screen printing apparatus according to claim 9 wherein the engagement arm is associated with a movement means to facilitate controlled movement of the engagement arm.

11. A screen printing apparatus according to claim 10 wherein the movement of the drive plate by the indexing drive mechanism involves the reciprocating movement of the second engagement means through an arcuate path.

12. A screen printing apparatus according to claim 6 wherein the drive plate is provided with a first engagement means in the form of a plurality of openings formed in a circumference of the drive plate and spaced about the circumference to scale according to the separation of the arm members extending from the rotor.

13. A screen printing apparatus according to claim 12 wherein the indexing drive mechanism also includes at least one engagement arm mounted separately from but engageable with, the first engagement means provided on the drive plate.

14. A screen printing apparatus according to claim 13 wherein the engagement arm is mounted relative to the base of the printing apparatus to provide sufficient leverage to rotate the drive plate.

15. A screen printing apparatus according to claim 12 wherein the engagement arm rotates in a complete circle during a cycle of movement, engaging the drive plate during only a portion of the circular cycle.

16. A screen printing apparatus according to claim 15 wherein the engagement arm is associated with a motor means to drive the circular movement of the engagement arm.

17. A screen printing apparatus according to claim 12 wherein the indexing drive mechanism also includes a rotary encoder to control the movement and/or the position of the engagement arm.

18. A screen printing apparatus according to claim 12 wherein a “home position” for the engagement arm is provided, at which position the engagement arm is free of the drive plate to allow the free or manual rotation of the drive plate and/or rotor.

19. A screen printing apparatus according to claim 1 wherein the indexing that takes place involves movement of the rotor through a particular arc length, and the length of the arc is determined according to the number of arms extending from the stator or the rotor.

20. A screen printing apparatus according to claim 1 wherein the indexing drive mechanism further including a torque limiting assembly including a first torque plate having at least one opening therein and a second torque plate having at least one opening therein, and at least one bearing member located partially in the at least one opening in both first and second torque plates, the torque plates closely spaced from one another and biased into the closely spaced condition, such that the torque plates rotate together until a sufficiently large torque differential occurs between the plates causing the at least one bearing member to dislodge from the at least one opening and the plates to separate, one torque plate rotating freely with respect to the other.

21. A screen printing apparatus according to claim 20 wherein the torque limiting assembly is mounted for rotation about a substantially vertical axis, the lower plate rotatably mounted in a fixed position and the upper plate biased downwardly toward the lower plate.

22. A screen printing apparatus according to claim 20 wherein each at least one opening provided in the first torque plate is shaped circumferentially with a ramped side and a sheer side, the ramped side of the opening provided on a trailing side of the opening in the direction of normal rotation and the sheer side oriented on the leading edge of the opening in the direction of normal rotation.

23. A screen printing apparatus according to claim 22 wherein a circumferential channel is provided in the first torque plate which is offset from the at least one opening such that once the bearing members have been dislodged from their respective openings, the bearings can rotate freely in the openings in the second torque plate and the channel of the first torque plate until the torque limiting assembly is reset.

24. A screen printing apparatus according to claim 22 wherein the height of the sheer side of the at least one opening in the first torque plate determines the magnitude of the limiting torque.

25. A stroke adjustment means for adjusting the stroke of a print head, the adjustment means comprising an arm member, an inner portion of which mounts the print head, means for setting the length of stroke required, a driving piston for driving the print head and limit or contact switches which provide a signal to a controller once the desired stroke has been made.

26. An attachment means for attaching a support assembly such as an arm member, to a supported member such as a workpiece support plate, the attachment means having at least one tapered opening on either the support assembly or the supported member and a tapered attachment member adapted to be received in the at least one opening and secured therein, on the other of the support assembly or the supported member.

27. A screen printing assembly according to claim 1 further including a height adjustment means for raising and lowering the rotor relative to the stator which is adjustable including at least one piston for driving a rocker arm which is in contact with the underside of the locating plate, a forward stroke of the piston resulting in the rotor rising and a rearward stroke resulting in the rotor lowering.

28. A screen printing assembly according to claim 1 further including a carousel screen printing apparatus in which at least a portion of the stator arms can be tilted to facilitate the use of portable drying devices for drying newly printed articles.
